(19) United States
(12) Patent Application Publication
(10) Pub. No.: US 2026/0148072 A1
(43) Pub. Date: May 28, 2026

(54) PROMPT OPTIMIZATION FOR LARGE LANGUAGE MODELS

(71) Applicant: Kyndryl, Inc., New York, NY (US)

(72) Inventors: Keri Wheatley, Sevierville, TN (US); Sanjana Sahayaraj, Chennai (IN)

(21) Appl. No.: 18/956,849

(22) Filed: Nov. 22, 2024

(51) Int. Cl. G06N 3/0895

(52) U.S. Cl. CPC G06N 3/0895

(57) ABSTRACT

A computer-implemented method includes: receiving, by a computing device, an input prompt; routing, by the computing device, the input prompt to one or more restructuring routes; restructuring, by the computing device, the input prompt to provide a restructured input prompt to reduce tokens; evaluating, by the computing device, the input prompt to the restructured input prompt to determine that thresholds are met; and sending, by the computing device, the restructured input prompt that meets the thresholds to a large language model.

### BACKGROUND

Aspects of the present invention relate generally to large language models and, more particularly, to input prompt optimization for large language models.

Large language models (LLMs) are deep learning models (e.g., artificial intelligence (AI) based programs) that perform natural language processing (NLP) tasks. These tasks may include, for example, generating, translating, and summarizing text cases. The LLMs are trained on massive amounts of data, e.g., billions of words and other content. LLMs are used in chatbots and virtual assistants which assist in customer inquiries, troubleshooting issues, providing recommendations or other useful information, or executing tasks, e.g., controlling smart devices.

### SUMMARY

In a first aspect of the invention, there is a computer-implemented method including: receiving, by a computing device, an input prompt; routing, by the computing device, the input prompt to one or more restructuring routes; restructuring, by the computing device, the input prompt to provide a restructured input prompt to reduce tokens; evaluating, by the computing device, the input prompt to the restructured input prompt to determine that thresholds are met; and sending, by the computing device, the restructured input prompt that meets the thresholds to a large language model.

In another aspect of the invention, there is a computer program product including one or more computer readable storage media having program instructions collectively stored on the one or more computer readable storage media. The program instructions are executable to: receive an input prompt prior to calling an API for a large language model; route the input prompt to one or more restructuring routes to optimize the input prompt, the routing based on analysis of the input prompt and user inputs; restructure the input prompt to reduce tokens using the one or more restructuring routes; evaluate that the restructured input prompt meets at least one predetermined threshold; and send the restructured input prompt to the large language model.

In another aspect of the invention, there is system including a processor, a computer readable memory, one or more computer readable storage media, and program instructions collectively stored on the one or more computer readable storage media. The program instructions are executable to: route an input prompt to one or more restructuring routes to reduce tokens of the input prompt, the routing based on an analysis of the input prompt and user inputs; restructure the input prompt to reduce tokens using one or more restructuring routes; determine that the restructured input prompt meets at least one predetermined threshold; send the restructured input prompt to the large language model upon meeting the at least one predetermined threshold; and rerouting the input prompt to different routes for different restructuring of the input prompt to reduce tokens when the at least one predetermined threshold is not met.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows an example of a prompt property detection in accordance with aspects of the present invention

FIG. 6 shows a flowchart of an exemplary method in accordance with aspects of the invention.

FIG. 7 shows an example of a route selection in accordance with aspects of the present invention

### DETAILED DESCRIPTION

Aspects of the present invention relate generally to large language models and, more particularly, to prompt optimization for large language models. For example, the system, method and related computer program product disclosed herein include a prompt optimizer engine for large language models (LLMs). The prompt optimizer engine, for example, restructures user input prompts to reduce the number of tokens used as an input to the LLM. In this way, costs can be significantly reduced.

According to aspects of the invention, the prompt optimizer engine may be embodied in a system, method and related computer program product and used to power artificial intelligence (AI). The prompt optimizer engine enables an iterative process of prompt restructuring through a combination of deterministic and pattern-based methods that balances between cost and peak performance for prompt properties and task type. To provide the prompt restructuring, the system, method and related computer program product provide a route selection based on detected prompt properties, user input thresholds, and/or system thresholds while allowing a user to control granularity of the input prompt restructuring to balance model training costs. The system, method and related computer program product also provides prompt restructuring evaluation and scoring using checks such as performance metrics and sanity checks. In this manner, aspects of the invention provide advantages over known methods such as providing optimized input prompts using iterative processes in large language models in a cost efficient manner.

In more specific embodiments, the system, method and related computer program product provides a technical solution to a technical problem by providing a tool and framework for prompt and cost optimization for LLMs. For example, the system, method and related computer program product reduces costs for each API call to an LLM by reducing the number of tokens needed for a user input prompt. By way of illustration, a user typically enters a prompt which triggers an API call of the LLM, which then returns an output. This user input prompt is unfiltered resulting in a large number of tokens, which becomes cost prohibitive due to the fact that charges are incurred based on the number of tokens. This problem is solved by aspects of the present invention, which is capable of decreasing (optimizing) the size of the input prompt by using iterative processes with different routing availability to restructure, e.g., reduce, the number of tokens in a user input prompt.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

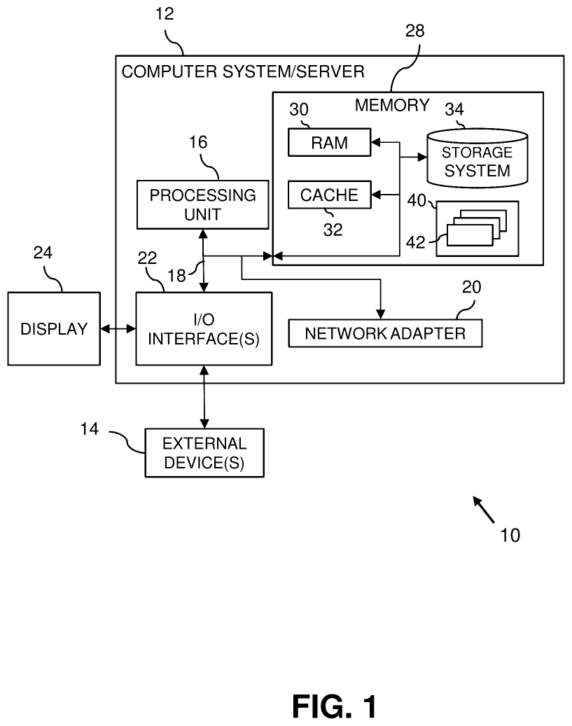

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

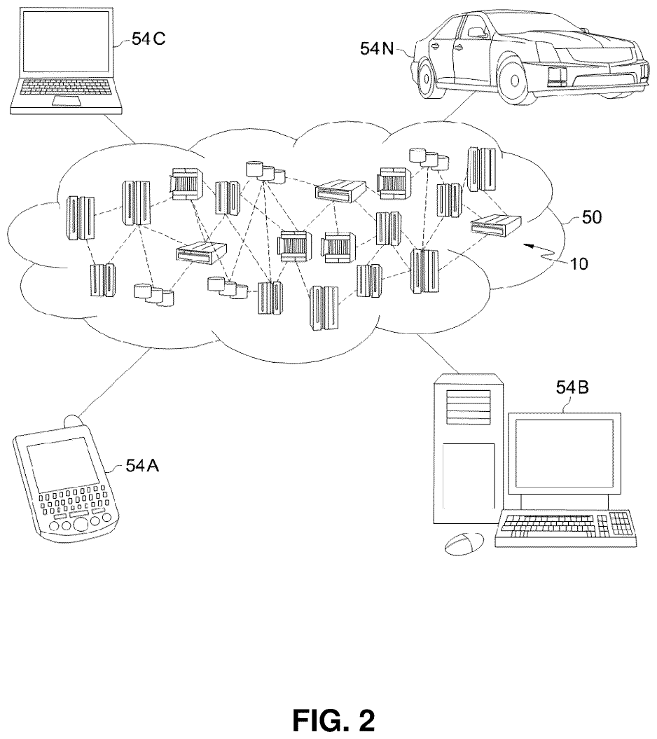

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

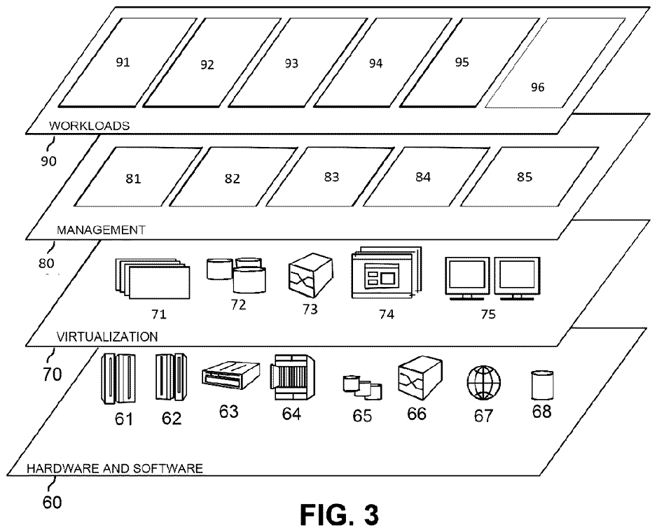

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:
Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.
Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and input prompt optimizer 96.

Implementations of the invention may include a computer system/server 12 of FIG. 1 in which one or more of the program modules 42 are configured to perform (or cause the computer system/server 12 to perform) one of more functions of the input prompt optimizer 96 of FIG. 3. For example, the one or more of the program modules 42 may be configured to: (i) provide an iterative method of prompt restructuring through a combination of deterministic and pattern-based methods that balances between cost and peak performance for prompt properties and task type; (ii) provide route selection based on detected prompt properties (e.g., prompt type), user input thresholds, and/or system thresholds; (iii) provide prompt restructuring evaluation and scoring based on multiple checks, such as performance metrics and sanity checks; and (iv) allowing the user to control granularity of the restructured prompt to balance model training and costs. In this way, it is now possible to review a user input prompt, make changes to the prompt through the use of different routes to reduce its size and, hence, reduce its cost profile. Accordingly, it is now more efficient to send user prompts to the API of the LLM.

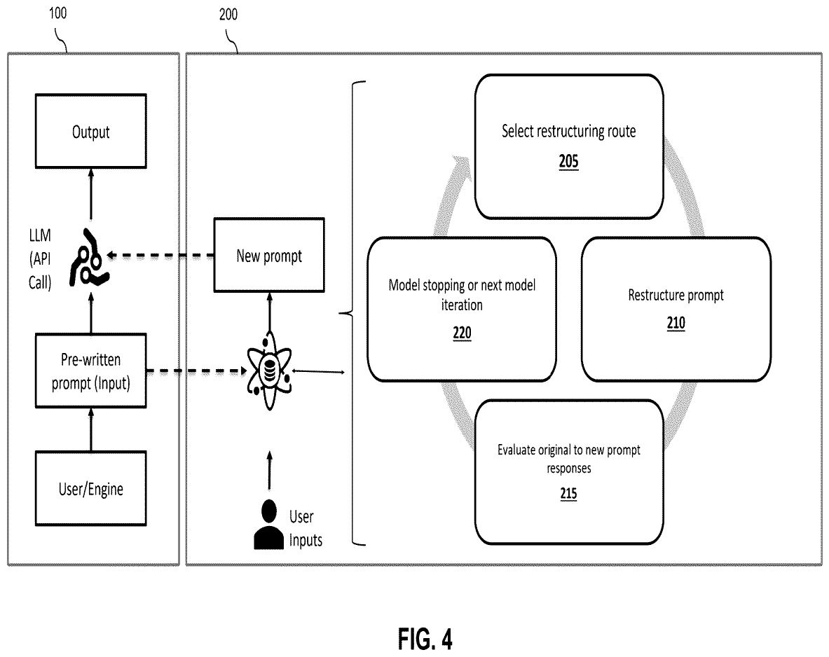

FIG. 4 shows a block diagram of an exemplary environment in accordance with aspects of the invention. In embodiments, the environment includes an LLM 100 and a prompt optimizer engine 200. In embodiments, the LLM 100 may be any conventional LLM which allows a user to enter a prompt, which calls an API of the LLM 100 and which returns an output. In embodiments, though, the prompt entered into the LLM 100 is diverted to the prompt optimizer engine 200. The prompt optimizer engine 200 will restructure the input prompt and send the restructured input prompt back to the LLM 100. This will result in an API call to the LLM, which will then proceed to providing an output based on the revised prompt (e.g., restructured input prompt). In embodiments, the restructured input prompt will be optimized, resulting in less tokens required or used and, hence, cost savings.

In embodiments, the prompt optimizer engine 200 comprises several modules or engines including, for example, a restructuring route engine 205, a restructure prompt engine 210, an evaluation or comparison engine which evaluates an original prompt to the new prompt 215 and a model stopping and next model iteration engine 220, each of which may comprise one or more program modules such as program modules 42 described with respect to FIG. 1. The prompt optimizer engine 200 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

The restructuring route engine 205 will specify a combination of prompt restructuring routes using rule-based and AI-based analysis of the user input prompt and user inputs. For example, the route selection may be based on user input thresholds and/or system thresholds. In further embodiments, the restructuring route engine 205 can be implemented using different classical models to determine route selection. These models may include, e.g., a boosted decision tree model, a predictive model, a logistic regression model, a boosted regression model, or a supervised learning model, amongst other models.

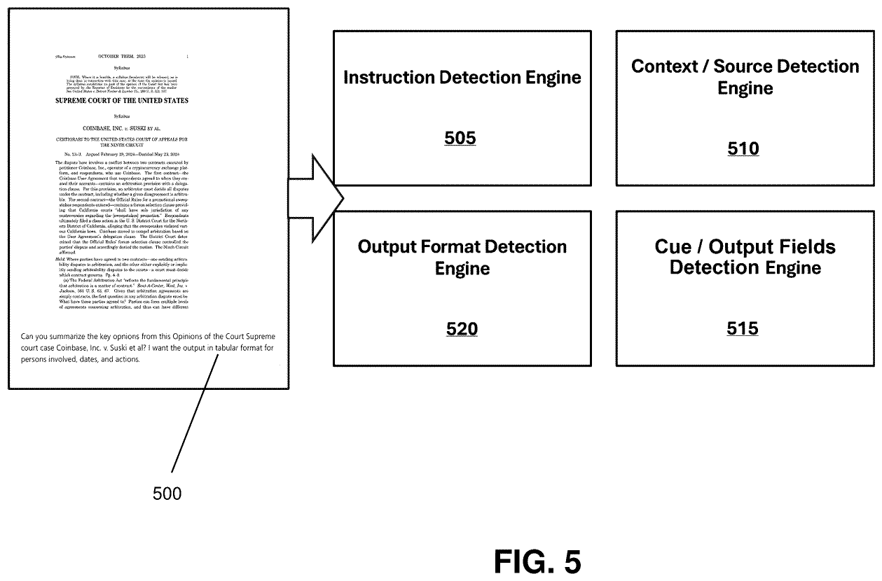

In using any of these models, the restructuring route engine 205 may look at different features for route selection including, for example, user inputs and/or detected prompt properties. The features may be, for example, (i) type of document, (ii) directions, (iii) required output tabular with fields persons, dates and actions, (iv) summarization requirements, (v) formatting, (vi) other user inputs, e.g., maximum model iterations, model training requirements for LLMs, (vii) API calls, (viii) auto-detected corpus of documents, (ix) type of sentiment analysis, (x) whether an output format is specified, (xi) rules based situations, and/or (xii) contextual information removal, etc., amongst other features. The features may also be historical patterns. Additional user inputs may be considered, for example, early stopping accuracy meeting a certain threshold for a predetermined accuracy, score, etc., number of API calls, use of different models, e.g., local models only, and cost and model runtime thresholds. The prompt properties as described with respect to FIG. 5 may be used to determine a particular route. Accordingly, the restructuring route engine 205 may use these features to select the best route for optimization. These routes can be, for example, summarization, WordNet lemmas, transformer paraphrasing, template based/rule based, contextual information removal, stop word removal, local GB LLM summarization, paraphrasing and combinations thereof, amongst other possible routes.

The restructure prompt engine 210 may use a combination of methods to restructure the original user prompt for token minimization using the specific selected routes. These methods may be, for example, deterministic, rule-based, summarization, embeddings, etc. More specifically and by way of non-limiting examples, the deterministic method may include techniques that use known and fixed data to produce a definite output without randomness or uncertainty. For example, the deterministic method may include: POS Tag; WordNet lemmas; syntax checks head and dependency of sentences; one to one mapped synonym replacement; or cosine similarity based embedding verification as various examples.

The restructure prompt engine 210 may also be template based/rule based, and may use other techniques such as transformer paraphrasing, summarization, tokenization and/or embedding to optimize the input prompt. The restructure prompt engine 210 may also use historical patterns such as, for example, prompt intent auto-detection including pattern based methods to determine intent and declarations from input prompt. The historical patterns may also include comparing route classification/scoring and cost analysis of route savings.

The evaluation or comparison engine 215 will determine whether the restructured input prompt meets system and/or user thresholds. This may include, for example, multifaceted scoring on response completeness, context relevance, response consistency, etc. The prompt evaluation may include, for example, a benchmark set for each instruction and task type, sanity checks, guardrail checks, and a scoring. A sanity check is a test to evaluate whether something is reasonable or makes sense. Guardrail metrics keep organizations and product teams on the right track and are used as a tool to ensure alignment with business goals and objectives.

The benchmark may include, amongst other examples, a percentage reduction in tokens to percentage reduction or maintenance of output quality, an optimal ratio reachable for a given task, and/or input and output format type. For example, a 50% reduction in token count resulting in 1% drop in accuracy, can be determined to be satisfactory (as provided by, for example, as a user input or system input). The sanity check may include formatting correctness and input to output token and semantic similarity distribution, which is a balance between hallucination and generative ability. The guardrail checks may include, amongst other examples, PII and privacy check, a harmful, hateful, or suggestive content check, and/or difference in output content type between the original user input and restructured input prompt.

A scoring system may also be utilized to balance cost and optimization. For example, the scoring system allows governance teams to rank the restructured input prompts based on criteria such as risk level, cost, and potential financial returns, in addition to whether the restructured input prompt will provide a same output, with the original input prompt being the source of the truth. In aspects of the invention, the scoring systems may assign comparative values to one or more restructured input prompts. So, for example, if the original input prompt and the restructured prompt provide the same output, a higher score can be provided to the restructured prompt. In this way, it is possible to score the restructured prompts for effectiveness, relevance, and/or consistency to ensure it is aligned with the original user input prompt.

In further aspects of the invention, the scoring system may include an evaluation of output relative to a set threshold for route finding. The scoring system may include task specific metrics such as a Bilingual Evaluation Understudy (BLEU) score for summarization. As should be understood by those of skill in the art, a BLEU score is a metric that measures the similarity between a machine-translated text and a reference translation. The score is a number between 0 and 1, with 0 indicating no overlap and 1 indicating perfect overlap. Moreover, the scoring system may provide LLM specific metrics such as context relevancy, answer relevancy, faithfulness etc. In addition, the scoring system may provide a weighted score across all metrics depending on task and output presets by the user or administrator.

In further aspects of the invention, a test can be performed against the LLM with the original input prompt and the restructured input prompt. For example, the original input prompt can call the LLM a predetermined amount of times to ascertain the output. The restructured input prompts can also be correlated to the output, with different scoring for the output based on the correlation of the original input prompt and the restructured input prompt. This can be used to ensure that the output is aligned between the original input prompt and the restructured input prompt.

The model stopping or next model iteration engine 220 determines whether the restructured input prompt meets all requirements and thresholds. If so, no further processing is required and the restructured input prompt may be fed into the LLM 100. If the restructured input prompt does not meet all requirements and/or thresholds, the AI (e.g., engine 205) may be used to reroute the input to different routes for further optimization. In this latter scenario, an iterative process will include further evaluation and restructuring of the input prompt using engines 205, 210, 215. In this way, the model stopping or next model iteration engine 220 may include route finder feedback loops. The route finder feedback loop may include multiple routes explored based on detected prompt properties. And the different routes are iteratively explored until a common benchmark across properties of the restructured input prompt is reached for a given cost. This sets a threshold for exploration of new routes, balancing between accuracy and time.

By way of example and as should now be recognized by one of ordinary skill in the art, the models described herein may require an accuracy threshold response in which accuracy may need to meet a certain threshold in which situation training or additional iterations can be provided. For example, in comparing the original input prompt to the restructured input prompt, the user can indicate that accuracy between the original input prompt to the restructured input prompt needs to be a predetermined percentage, e.g., 1% to 100%, with the higher percentage of accuracy requiring more training and additional iterations. In the case that the accuracy threshold is not met, different routes will be explored to restructure the input prompt and obtain the required accuracy threshold.

Similarly, in aspects of the present invention, the user may select the amount of iterations for higher or lower accuracy. In this way, for example, if less iterations are required, the model stopping or next model iteration engine 220 will require early stops after the number of iterations are met (regardless of whether an accuracy threshold has been met, in one illustrative non-limiting example). So, in these cases, once a minimum threshold of iterations is reached, it is no longer necessary to continue spending resources, e.g., money, on training or iterative processes. This same scenario can be used for meeting certain thresholds for scores, e.g., if a certain user selected score is not met, the model stopping or next model iteration engine 220 will continue to a next iteration to find different routes to restructure the input prompt and meet the required score. In this way, it is possible to balance between cost constraints of model training, accuracy, iterations, etc.

FIG. 5 shows an example of a prompt property detection process in accordance with aspects of the present invention. In FIG. 5, an input prompt 500 is provided by the user. The input prompt 500 may be parsed by known natural language processes. In this case and as a non-limiting example, the input prompt may be, “can you summarize the key options from this Opinion of the Court Supreme court case Coinbase, Inc. v Suski et al? I want the output in a tabular format for persons involved, dates, and actions.” In this example, the prompt detection includes instruction detection 505, contact/source detection 510, output format detection 515 and cue/output fields detection 520. By way of example, the instruction detection 505 will determine which preprocessing routes to use for token minimization, e.g., summarization, based on the use of “summarize” in the prompt. The contact/source detection 510 may be an engine that assists in ascertaining historical patterns for contact type, e.g., in this case a legal document. The output format detection 515 may be an engine that balances between syntax and grammar focused methods vs. semantics and context focused methods, e.g., tabular (based on the use of “tabular format”. The cue/output fields detection 520 may be used to identify which parts of the document to not skim over during the preprocessing. In further aspects of the invention, any combination of these features may be provided within the restructuring route engine 205 and/or the restructure prompt engine 210 as examples. Accordingly, by using the prompt, itself, it is possible to determine which route to take in order to optimize the input prompt.

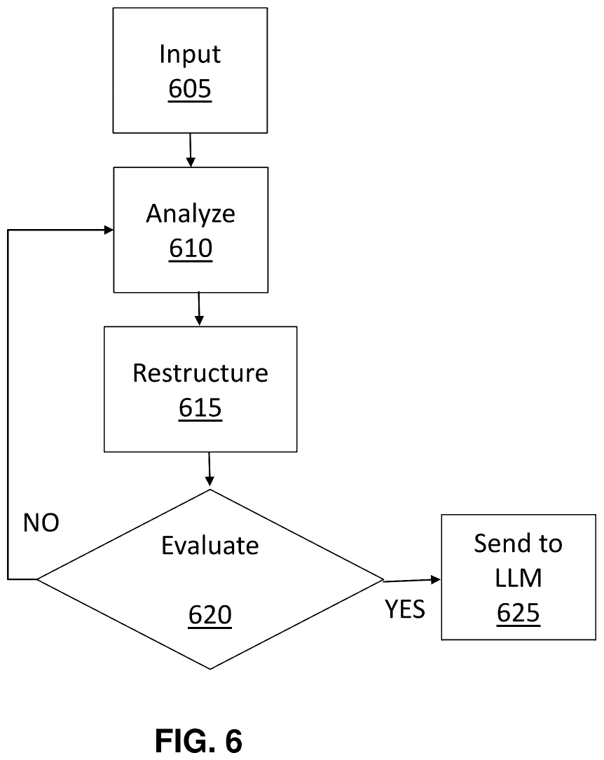

FIG. 6 shows a flowchart of an exemplary method in accordance with aspects of the present invention. Steps of the method may be carried out in the environment of FIG. 4 and are described with reference to elements depicted in FIG. 4. At step 605, the system will retrieve or obtain an input prompt from a user, prior to an API call to an LLM. At step 610, the system will analyze the input prompt and determine a best route for prompt restructuring. At step 615, the system will restructure the prompt based on the selected routes. At step 620, the system will evaluate the original prompt to the restructured prompt to ensure that the restructured prompt meets all of requirements, thresholds, scoring, relevancy and/or completeness, etc. If all of the selected requirements are met, at step 625, the processing for restructuring will stop and the restructured prompt will be fed back into the LLM to generate an output. If all of the requirements are not met, an iterative process will occur where a different route will be selected at step 610.

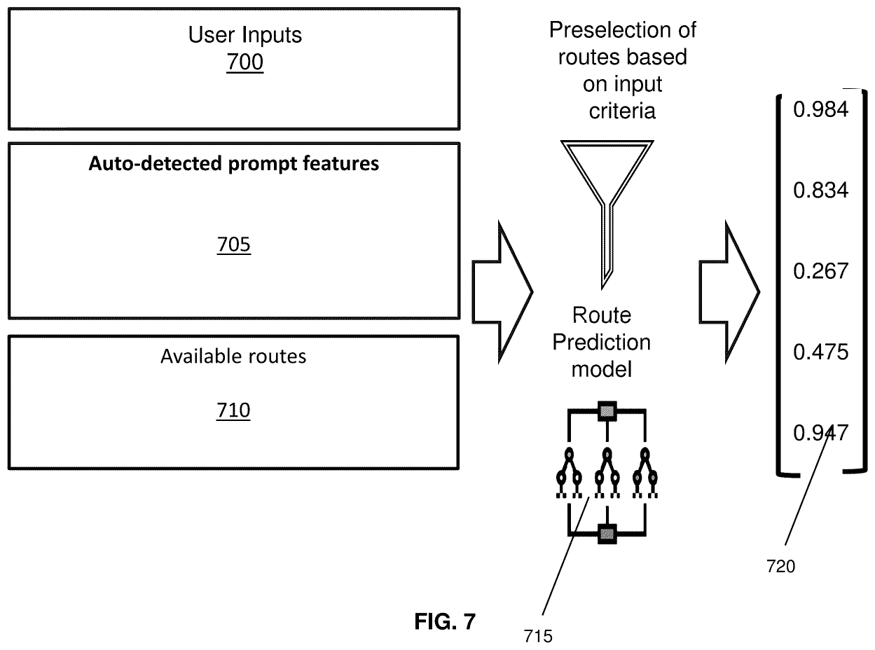

FIG. 7 shows an example route selection process in accordance with aspects of the present invention. In this example, the user input 700 for prompting of route selection includes, for example, early stopping accuracy threshold reaches 80%, No API calls and use of local models only, and cost and model runtime thresholding should be used. Other inputs may also be used such as text sampling, use of metadata or HTML tags, etc. The auto-detected prompt features 705 may include, for example, one-hot encoded (Prompt type: document+directions)., one hot encoded (Format: tabular), text required fields (persons, dates actions), and requirements summarization+formatting. With these inputs, available routes may be determined at box 710. These routes may include, as non-limiting examples, summarization+POS tagging, rules based+POS tagging, embeddings+cosine similarity+rules based, Embeddings+cosine similarly, WordNet lemmas and POS tagging+synonym replacement. With this information, the system will provide a route using a route prediction model 715 (e.g., prompt optimizer engine), noting the highest probability that the routes will meet certain thresholds. For example, scores can be provided to ascertain the best route as shown at reference numeral 725. As already noted herein, the route prediction model 715 may use any classical model, such as a regression model, boosted regression model, etc. to determine the best route.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, an input prompt;
routing, by the computing device, the input prompt to one or more restructuring routes;
restructuring, by the computing device, the input prompt to provide a restructured input prompt to reduce tokens;
evaluating, by the computing device, the input prompt to the restructured input prompt to determine that thresholds are met; and
sending, by the computing device, the restructured input prompt that meets the thresholds to a large language model.

2. The method of claim 1, wherein the restructured input prompt is rerouted to different restructuring routes when the thresholds are not met.

3. The method of claim 2, wherein the routing is an iterative process until the restructured input prompt meets the thresholds.

4. The method of claim 3, wherein the iterative process comprises a combination of deterministic and pattern-based methods that balances between cost and optimization.

5. The method of claim 1, wherein the restructuring of the input prompt comprises a combination of prompt structuring using at least one of a rule based or artificial intelligence based analysis of the input prompt and user inputs.

6. The method of claim 1, wherein the route selection is based on detected prompt properties.

7. The method of claim 1, wherein the route selection is based on user input thresholds.

8. The method of claim 1, wherein the route selection is based on user system thresholds.

9. The method of claim 1, further comprising scoring the restructured input prompt to determine an optimized route.

10. The method of claim 1, further comprising a prompt restructuring evaluation and scoring process based on multiple checks.

11. The method of claim 10, wherein the multiple checks include at least one of performance metrics, sanity checks or guardrail checks.

12. The method of claim 1, wherein the computing device includes software provided as a service in a cloud environment.

13. A computer program product comprising one or more computer readable storage media having program instructions collectively stored on the one or more computer readable storage media, the program instructions executable to:
receive an input prompt prior to calling an API for a large language model;
route the input prompt to one or more restructuring routes to optimize the input prompt, the routing based on analysis of the input prompt and user inputs;
restructure the input prompt to reduce tokens using the one or more restructuring routes;
evaluate that the restructured input prompt meets at least one predetermined threshold; and
send the restructured input prompt to the large language model.

14. The computer program product of claim 13, wherein user inputs and/or detected prompt properties are used for the routing to the one or more restructuring routes.

15. The computer program product of claim 13, wherein the restructuring uses at least one of deterministic, pattern based, template based or rules based model to minimize tokens of the input prompt.

16. The computer program product of claim 15, wherein historical patterns are used to restructure the input prompts.

17. The computer program product of claim 13, wherein the predetermined threshold comprises at least one of sanity checks, guardrail checks, or a scoring used on the restructured input prompt.

18. The computer program product of claim 13, wherein the predetermined threshold comprises a benchmark comprising a percentage reduction in tokens to percentage reduction or maintenance of output quality of the restructured input prompt.

19. The computer program product of claim 13, wherein the routing, restructuring and evaluating are provided in an iterative process until the restructured input prompt meets the predetermined thresholds.

20. A system comprising:
a processor, a computer readable memory, one or more computer readable storage media, and program instructions collectively stored on the one or more computer readable storage media, the program instructions executable to:
route an input prompt to one or more restructuring routes to reduce tokens of the input prompt, the routing based on an analysis of the input prompt and user inputs;
restructure the input prompt to reduce tokens using one or more restructuring routes;
determine that the restructured input prompt meets at least one predetermined threshold;
send the restructured input prompt to the large language model upon meeting the at least one predetermined threshold; and
rerouting the input prompt to different routes for different restructuring of the input prompt to reduce tokens when the at least one predetermined threshold is not met.
